(19) United States
(12) Patent Application Publication
(10) Pub. No.: US 2004/0161727 A1
(43) Pub. Date: Aug. 19, 2004

(54) System and method for selecting colors and patterns for desing using a virtual environment

(76) Inventor: Michael L. Brodine, Parkside, PA (US)

Correspondence Address: Eric A. LaMorte, LaMorte & Associates, P.C., P. O. Box 434, Yardley, PA, 19067, US

(21) Appl. No.: 10/357,549

(22) Filed: Feb. 5, 2003

(51) Int. Cl. G09B 25/00

(52) U.S. Cl. 434/72; 434/365

(57) ABSTRACT

A system and method of selecting a color scheme of an actual environment by evaluating different color schemes in a virtual environment. To utilize the system, a virtual image of a real environment is created. This can he done by scanning photographs of the real environment into a computer. The real environment that contains a plurality of different surfaces having different colors and design patterns. The computer identifies the boundaries of each of said different surfaces in the virtual image that is created. The computer then considers each of the different surfaces as a variable field. Using a computer interface, a user selectively varies the colors and design patterns of any of the surfaces in the virtual image. The different surfaces are altered until the color scheme of the virtual image matches a desired color scheme.

### BACKGROUND OF THE INVENTION

1. Field of the Invention

In general, the present invention relates to computer systems that are used to selectively vary a virtual image. More particularly, the present invention relates to computer systems and methods that are used to vary a virtual environment so as to make design choices in the virtual environment that will be used in a corresponding real environment.

2. Description of the Prior Art

Interior design is the name commonly given to the practice of coordinating and decorating a room or other location. One of the objects of interior design is to create a room that has a complimentary color scheme among the various paints, wallpapers, upholstery, floor coverings and other objects in the room. When a person decides to change the color scheme of a room, that person typically views sample cards of different paint colors, swatches of various wallpapers, samples of different upholstery materials and the like. The paint, wallpaper and other materials selected must complement each other and must not clash with the color of the furniture and other objects that will be placed in the remodeled room.

To ensure a proper color scheme, people often take the paint sample cards, wallpaper swatches upholstery samples and other sample items to the room being remodeled. The various samples are compared to one another and are compared to the furniture and objects that are to be placed in that room.

Unfortunately, not everyone can truly envision what a wall will look like once it has been painted and/or wallpapered by viewing small sample cards and swatches. It is also difficult for some people to envision new upholstery on furniture from viewing a small sample swatch. As such, people are often unhappy with their selection of colors and pattern, once those colors and patterns are applied. This causes the person to either live with the unpleasing color scheme selection or repurchase new paint, new wallpaper and new upholstery. The costs associated with having a room painted and wallpapered are significant. Similarly, the costs of having draperies made and having furniture upholstered are also significant. Consequently, great effort is often made to get the color scheme correct the first time.

In the prior art, computer systems have been developed to help people select complementary color schemes for use in interior design. In such systems, various colors and patterns are read into a computer. The colors and patterns can then be mixed and matched by a person using the computer. Such systems even enable the selected colors to be displayed in a computer generated rendition of a room. Such prior art systems are exemplified by U.S. Pat. No. 5,751,829 to Ringland, entitled, Spectrally Coordinated Pattern Search-Imaging System And Method.

A problem associated with such prior art systems is that the systems do not enable a person to accurately envision the room that they are decorating with the color scheme they have selected. Such prior art systems have no ability to compare the color scheme selected to the objects that will be in that room, the floor covering of the room or the upholstery used on the furniture in that room. Consequently, people who use such prior art systems often select a color scheme that looks good in the computer but does not look good when applied in their home.

A need therefore exists for a system and method that will enable people to accurately simulate different. color schemes using actual images of the room being decorated. In such a manner, people can envision different color schemes in the environment of the room being decorated including the furniture, upholstery, floor coverings and colored objects that are in that room. This need is met by the present invention as described and claimed below.

### SUMMARY OF THE INVENTION

The present invention is a system and method of selecting a color scheme for an actual environment by evaluating different color schemes in a virtual environment. To utilize the system, a virtual image of a real environment is created. This can be done by scanning photographs of the real environment into a computer. The real environment contains a plurality of different surfaces having different colors and design patterns. The computer identifies the boundaries of each of said different surfaces in the virtual image that is created. The computer then considers each of the different surfaces as a variable field.

Using a computer interface, such as a keyboard or a mouse, a user selectively varies the colors and design patterns of any of the surfaces in the virtual image. The different surfaces are altered until the color scheme of the virtual image matches a desired color scheme. An indication is then provided of the colors and design patterns selected so that the selected color scheme can be reproduced in the real environment that the virtual image represents.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a block diagram schematic of a system in accordance with the present invention; and

FIG. 2 is an exemplary embodiment of a display created by the present invention system.

### DETAILED DESCRIPTION OF THE INVENTION

Although the present invention system can be used by a person or interior designer to select the color scheme of a home's exterior, a flower garden, clothing and the like, the present invention system is especially well suited for use in selecting the color scheme of an interior room. Accordingly, by way of example, the present invention system will be configured for use in selecting the color scheme of an interior room in order to set forth one of the best modes contemplated for the invention.

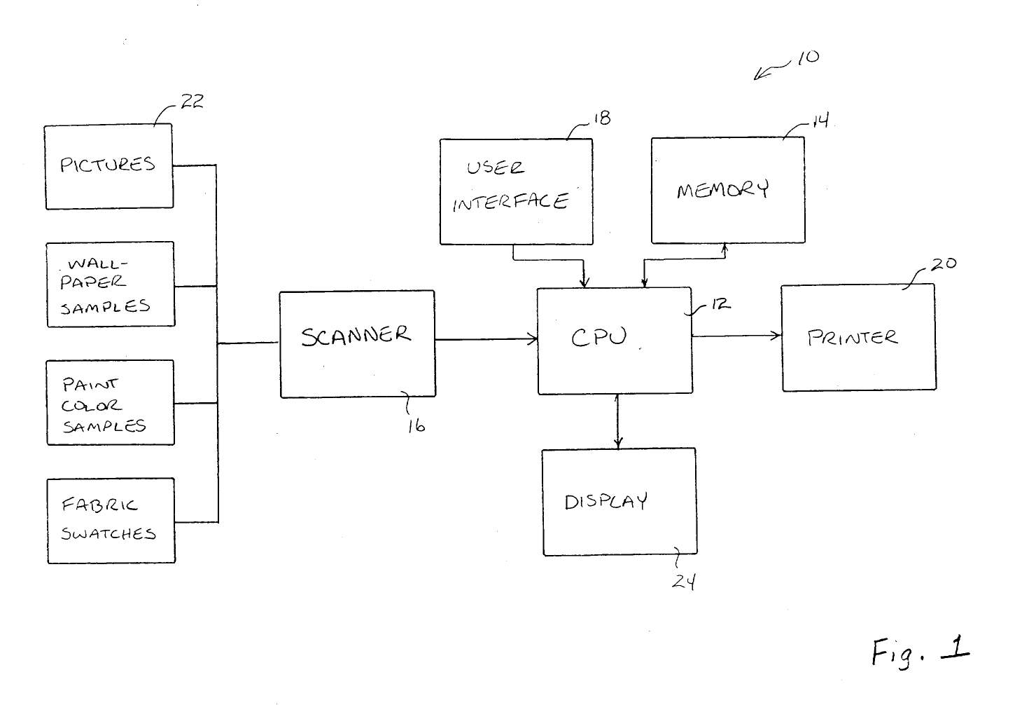

Referring to FIG. 1, an exemplary embodiment of a system 10 is shown in accordance with the present invention. The system 10 includes a central processing unit 12, such as a personal computer. The central processing unit 12 has a memory 14. Within the memory 14 are stored the digital images of many different types of wallpaper patterns, upholstery patterns, floor covering patterns and the like. Also contained within the memory 14 of the central processing unit 12 are numerous different color patterns and varying shades for those color patterns.

An optical scanner 16 is coupled to the central processing unit 12. The optical scanner 16 scans any object placed on the scanner and produces a digital image of the scanned object that can be read by the central processing unit 12. A user interface 18, such as a keyboard, and a color printer 20 are also connected to the central processing unit 12.

To utilize the system 10, a person takes pictures 22 of the room that is to be remodeled. Each picture 22 is then scanned utilizing the optical scanner 16. The optical scanner 16 creates a digital representation for each of the pictures 22 scanned. The pictures 22 show the room to be remodeled including the objects in the room and the colors of various items in the room that may not be changed during the remodeling, such as upholstery, floor coverings, lamp shades and the like.

The step of scanning pictures can be eliminated if the pictures 22 are taken on a digital camera or are otherwise reduced into a digital format. If pictures 22 are already in a digital format, the pictures can be directly downloaded to the central processing unit 12 using a disk or a telecommunications link.

Once digital representations of pictures 22 are read by the central processing unit 12, the central processing unit 12 distinguishes the different objects contained in the image, based upon the color pattern of the various objects in the image. For example, if a wall has wallpaper of a certain pattern on it, the central processing unit 12 can identify all surfaces in the image that are covered by that same pattern. Similarly, if furniture is covered with upholstery of a certain color, the central processing unit can identify all surfaces covered in that upholstery.

Once areas of different color schemes are identified, the central processing unit 12 makes each identified area a variable field within that image. In each variable field, the changes in color intensity caused by lighting and shadows is calculated, thereby creating lighting variation values for each point on the variable field.

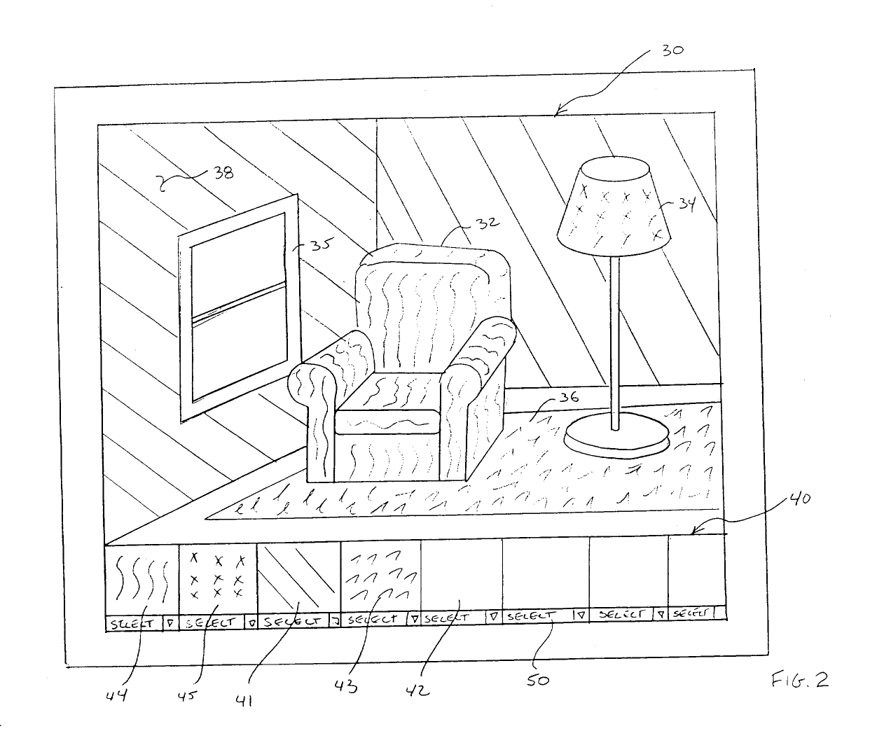

After the digital image is divided into variable fields and lighting variation values are calculated for each of the variable fields, the image is displayed on the display monitor 24. Referring to FIG. 2, an example of such a display is illustrated. In the shown example, an image of a room 30 is shown having a chair 32, a lamp shade 34, a window having trim 35, floor covering 36 and wallpaper 38. The upholstery of the chair 32, the lamp shade 34, the window trim 35, the wallpaper 38 and the floor covering 36 all have different color patterns that are identified as variable fields by the central processing unit 12 (FIG. 1). Both the window and the lamp cast light onto each of the surfaces in the room. As such, there are lighting variations within each identified field. The light variations are identified on a point-by-point basis within each of the identified fields. As such, each point in each field has a lighting variable associated with it.

At the bottom of the display is provided a selection pallet 40. A position is provided on the pallet 40 that corresponds to each of the variable fields within the image. As such, there is a pallet selection 41, 42, 43, 44, 45 that corresponds to the wallpaper 38, the window trim 35, the floor covering 36, the upholstery 32 and the lamp shade 34, respectively. Below each space on the selection pallet is a selection icon 50. By pointing the screen curser to the selection icon 50, a person can select from any color or pattern that is held in the memory of the central processing unit. Once a new color or pattern is selected, the variable field in digital image is changed to that color or that pattern. The new color or pattern is varied using the light variation values for the points field. Consequently, using a real image of a person's room under real lighting conditions, a person can selectively change any paint color, wallpaper type, floor covering, upholstery, lamp shades or any other variable element in a virtual environment. Once a selected color scheme is chosen, the image of the virtual room in that color scheme can be printed out on the color printer 20 (FIG. 1). Furthermore, information about the different colors, wallpapers and materials selected are printed out so a person. can purchase these items.

Referring back to FIG. 1, it will be understood that if the memory 14 of the central processing unit 12 does not contain the color sample, wallpaper sample, or swatch desired by a person, these materials can be scanned into the memory 14 of the central processing unit using the optical scanner 16.

The present invention system 10 enables a person to print out images of their own room in a variety of different color schemes. A person can then view the

[symbol]

What is claimed is:

1. A method of selecting a color scheme using a virtual environment, said method comprising the steps of:
providing a virtual image of a real environment that contains a plurality of areas of different colors and design patterns;
identifying the boundaries of each of said plurality of areas in said virtual image;
selectively varying the colors and design patterns in at least some of said plurality of areas, thereby altering the color scheme of said virtual image until a desired color scheme is obtained; and
providing an indication as to the colors and design patterns selected so that said desired color scheme can be reproduced in the real environment that the said virtual image represents.

2. The method according to claim 1, wherein said step of providing a virtual image of a real environment includes the substeps of:
taking a color photograph of said real environment;
scanning said color photograph on an optical scanner to produce a corresponding digital image of said real environment; and
reading said digital image into a central processing unit that creates a virtual environment corresponding to said digital image.

3. The method according to claim 1, wherein said step of providing a virtual image includes the substeps of:
creating a digital image of the real environment;
reading said digital image into a central. processing unit that produces a virtual environment corresponding to said digital image.

4. The method according to claim 1, wherein said step of selectively varying the colors and design patterns in at least some of said plurality of areas, includes the substeps of:
providing a computer memory having a multitude of different colors and design patterns stored therein;
accessing said computer memory;
selecting at least one color from said computer memory;
identifying at least one of said plurality of areas in said virtual image; and
altering the color associated with the identified area in the virtual image to match the color selected.

5. The method according to claim 1, wherein said step of selectively varying the colors and design patterns in at least some of said plurality of areas, includes the substeps of:
providing samples of colors and design patterns;
scanning said colors and said design patterns into a format that can be read by a computer;
selecting at least one color scanned;
identifying at least one of said plurality of areas in said virtual image; and
altering the color associated with the identified area in the virtual image to match the color selected.

6. The method according to claim 1, further including the step of identifying lighting variables in each of said plurality or areas in said virtual image.

7. The method according to claim 6, further including the step of applying said lighting variables to each of said plurality of areas altered in said virtual image.

8. The method according to claim 1, wherein said real environment is an interior room.

9. The method according to claim 8, wherein said plurality of areas are selected from a group consisting of walls, trim, floor coverings, upholstery and draperies.

10. A method of selecting a color scheme for a room, comprising the steps of:
taking at least one color photograph of an existing room;
scanning said at least one photograph into a computer;
creating a virtual rendition of the room from said at least one photograph;
selectively altering the colors and patterns of surfaces in the virtual rendition of the room until a desired color scheme is achieved; and
indicating the colors and patterns selected in said desired color scheme.

11. The method according to claim 10, wherein the photograph of the room contains surfaces of different colors and design patterns and said method further includes the steps of identifying the boundaries of each of said surfaces in said virtual rendition of the room.

12. The method according to claim 11, further including the step of identifying lighting variables on each of said surfaces in at least one photograph.

13. The method according to claim 12, further including the step of applying said lighting variables to each of said surfaces altered in said virtual image.

14. A system for selecting a color scheme of a predetermined environment, comprising:
a scanner for scanning at least one color photograph of said predetermined environment:
a computer coupled to said scanner for creating a virtual rendition of said predetermined environment, wherein said computer identifies different surfaces in the virtual rendition of said predetermined environment;
a display monitor for displaying said virtual rendition of said predetermined environment;
a user interface for enabling a person to identify any of said different surfaces in the virtual rendition of said predetermined environment and to instruct said computer to alter the color scheme associated with that surface.

15. The system according to claim 14, wherein said computer determines variations in color caused-by lighting on each of said different surfaces and applies those variation to any new color selected with said user interface.
